(19) United States
(12) Patent Application Publication
(10) Pub. No.: US 2025/0042236 A1
(43) Pub. Date: Feb. 6, 2025

(54) BATTERY MODULE FOR REFUSE COLLECTION VEHICLE

(71) Applicant: The Heil Co., Chattanooga, TN (US)

(72) Inventors: Stanley L. Maroney, Attalla, AL (US); Bryan Stewart, Chattanooga, TN (US); Tony Lawayne Coffey, Dawson, AL (US); Mark Fraas, Centre, AL (US)

(21) Appl. No.: 18/792,139

(22) Filed: Aug. 1, 2024

Related U.S. Application Data
(60) Provisional application No. 63/517,016, filed on Aug. 1, 2023.

(51) Int. Cl. B60K 1/04; B65F 3/00

(52) U.S. Cl. CPC B60K 1/04; B65F 3/00; B60K 2001/0416

(57) ABSTRACT

A refuse collection vehicle includes a chassis, a refuse collecting body supported by the chassis, a tailgate coupled to the refuse collecting body, and at least one battery compartment configured to receive one or more batteries. The at least one battery compartment is positioned within an interior volume of the refuse collecting body.

### CROSS-REFERENCE TO RELATED APPLICATION

This application claims the benefit under 35 U.S.C. § 119(e) of U.S. Patent Application No. 63/517,016, entitled “Battery Module For Refuse Collection Vehicle,” filed Aug. 1, 2023, which is incorporated herein by reference in its entirety.

### TECHNICAL FIELD

This disclosure relates to systems and methods for attaching one or more batteries to a refuse collection vehicle.

### BACKGROUND

Refuse collection vehicles collect solid waste and transport the solid waste to landfills, recycling centers, or treatment facilities. In recent years, electric refuse collection vehicles have been introduced in an effort to reduce carbon emissions and hydraulic fluid leaks. Replacing the combustion engines and/or hydraulic pumps of conventional refuse vehicles with electric motors and actuators has raised a host of new design challenges. Thus, methods and equipment for improving electric refuse collection vehicles are sought.

### SUMMARY

In an example implementation, a refuse collection vehicle includes a chassis, a refuse collecting body supported by the chassis, a tailgate coupled to the refuse collecting body, and at least one battery compartment configured to receive one or more batteries. The at least one battery compartment is positioned within an interior volume of the refuse collecting body.

In an aspect combinable with the example implementation, a longitudinal axis of the at least one battery compartment is aligned with a longitudinal axis of the refuse collecting body.

In another aspect combinable with any of the previous aspects, the interior volume includes a refuse collection area and the at least one battery compartment is separated from refuse collection area.

In another aspect combinable with any of the previous aspects, the at least one battery compartment is separated from refuse collection area by a portion of a floor of the refuse collecting body.

In another aspect combinable with any of the previous aspects, a portion of the floor is curved inward to define a space corresponding to the at least one battery compartment.

In another aspect combinable with any of the previous aspects, the at least one battery compartment is separated from refuse collection area by at least one panel that covers the battery compartment.

In another aspect combinable with any of the previous aspects, the at least one panel is curved inward to define a space corresponding to the at least one battery compartment.

In another aspect combinable with any of the previous aspects, the refuse collection vehicle includes an ejector configured to eject refuse from the refuse collection area.

In another aspect combinable with any of the previous aspects, the refuse collection vehicle includes one or more body components powered by the one or more batteries.

In another aspect combinable with any of the previous aspects, the at least one battery compartment is positioned above a frame rail of the chassis.

In another aspect combinable with any of the previous aspects, the refuse collection vehicle includes a panel configured to cover the at least one battery compartment.

In another aspect combinable with any of the previous aspects, the panel can be moved between an open position and a closed position.

In another aspect combinable with any of the previous aspects, the one or more batteries can be accessed from outside the refuse collecting vehicle when the panel is in an open position.

In another aspect combinable with any of the previous aspects, the one or more batteries cannot be accessed from outside the refuse collecting vehicle when the panel is in a closed position.

In another aspect combinable with any of the previous aspects, the panel includes an upper portion configured to cover the one or more batteries and a lower portion configured to cover cabling attached to the one or more batteries.

In another aspect combinable with any of the previous aspects, the at least one battery compartment includes at least one support structure configured to support the one or more batteries.

In another aspect combinable with any of the previous aspects, the at least one support structure is angled downwards towards a center line of the interior volume.

In another aspect combinable with any of the previous aspects, the refuse collection vehicle includes a plurality of cables configured to electrically couple the one or more batteries to a battery management system.

In another aspect combinable with any of the previous aspects, the at least one battery compartment includes a first battery compartment positioned proximate a first side of the interior volume; and a second battery compartment positioned proximate a second side of the interior volume opposite the first side of the interior volume.

In another aspect combinable with any of the previous aspects, the refuse collection vehicle includes cabling that electrically couples one or more batteries in the first battery compartment and one or more batteries in the second battery compartment to a battery management system.

In another aspect combinable with any of the previous aspects, the refuse collection vehicle includes a channel extending between the first battery compartment and the second battery compartment, wherein the cabling is positioned within the channel.

In another aspect combinable with any of the previous aspects, the at least one battery compartment further includes a third battery compartment positioned proximate the first side of the interior volume; and fourth battery compartment positioned proximate the second side of the interior volume.

In another aspect combinable with any of the previous aspects, the one or more batteries includes 20 batteries.

In another aspect combinable with any of the previous aspects, the refuse collection vehicle includes a charging port for charging the one or more batteries

In another aspect combinable with any of the previous aspects, the refuse collection vehicle includes one or more sensors to detect at least one of a voltage, a temperature, or a charging level of each battery of the one or more batteries.

Particular implementations of the subject matter described in this specification can be implemented so as to realize one or more of the following advantages.

For example, the refuse collection vehicle of the present disclosure can provide improved weight distribution of batteries used to power one or more vehicle body components, which improves the stability of the refuse collection. For example, by positioning one or more batteries along the body of the refuse collection vehicle and over one or more frame rails of the chassis that is supporting the refuse collection vehicle, as described herein, the weight of the batteries is well-supported and distributed over the length of the body of the refuse collection vehicle.

In addition, by coupling the batteries that are used to power one or more vehicle body components to the body of the vehicle, rather than to the cab of the vehicle or to the chassis supporting the vehicle, the refuse collection vehicle of the present disclosure can allow for greater variability in the types of chasses and cabs that can be used together with the body of the refuse collection vehicle without requiring design alterations to the cab or chassis. Further, by coupling the batteries that are used to power one or more vehicle body components to the body of the vehicle, rather than to the cab of the vehicle or to the chassis supporting the vehicle, the refuse collection vehicle of the present disclosure can provide increased space within the cab of the vehicle and on the chassis supporting the vehicle.

In addition, the refuse collection vehicle of the present disclosure can be configured to enable efficient and easy replacement of batteries used to power one or more vehicle body components. For example, the refuse collection vehicle of the present disclosure enables an operator to access the batteries from the exterior of body of the refuse collection vehicle and remove the batteries from the vehicle by hand without the requiring specialized equipment. In addition, the refuse collection vehicle of the present disclosure can be configured to enable charging of one or more batteries used to power one or more vehicle body components of the vehicle without removing the respective batteries from the vehicle.

Further, the positioning of the batteries used to power one or more vehicle body components of the refuse collection vehicle of the present disclosure reduces the risk of damage to the batteries resulting from an impact to the vehicle (e.g., during a collision with another vehicle or another object, such as a tree limb).

It is appreciated that methods in accordance with the present specification may include any combination of the aspects and features described herein. That is, methods in accordance with the present specification are not limited to the combinations of aspects and features specifically described herein, but also include any combination of the aspects and features provided.

The details of one or more implementations of the subject matter described in this disclosure are set forth in the accompanying drawings and the description below. Other features, objects, and advantages of the subject matter will be apparent from the description and drawings, and from the claims.

### DESCRIPTION OF DRAWINGS

FIG. 1 is a side, schematic view of an example rear-loader refuse collection vehicle.

FIG. 2 is perspective, schematic view of a street side of the refuse collection vehicle of FIG. 1.

FIG. 3 is another perspective, schematic view of the refuse collection vehicle of FIG. 1.

FIG. 4A is a cross-sectional rear view of the refuse collection vehicle of FIG. 1.

FIG. 4B is a detailed view of portion A of FIG. 4A.

FIG. 4C is a detailed cross-sectional view of a portion of the refuse collection vehicle of FIG. 1.

FIG. 4D is a perspective view of an enclosure of a battery compartment of the refuse collection vehicle of FIG. 1.

FIG. 4E is a perspective view of a portion of the enclosure of FIG. 4D with a battery cell removed.

FIG. 5 is another perspective, schematic view of the refuse collection vehicle of FIG. 1.

FIG. 6 is a detailed view of a cabling cross-over channel of the refuse collection vehicle of FIG. 1.

FIG. 7 is perspective, schematic view of an example side-loader refuse collection vehicle.

FIG. 8 is perspective, schematic view of an example front-loader refuse collection vehicle.

FIGS. 9 and 10 are side, schematic views of another example rear-loader refuse collection vehicle.

FIG. 11 is a cross-sectional rear view of the refuse collection vehicle of FIGS. 9 and 10.

FIG. 12 is a cross-sectional rear view of another example refuse collection vehicle.

FIG. 13 is a perspective, rear view of the refuse collection vehicle of FIG. 12.

FIG. 14 is a cross-sectional rear view of another example refuse collection vehicle.

FIG. 15 is a schematic illustration of an example control system or controller of the refuse collection vehicle.

### DETAILED DESCRIPTION

The waste collection vehicle of the present disclosure includes a battery compartment that is positioned within an interior volume of the waste collection vehicle. The battery compartment of the waste collection vehicle of the present disclosure is configured to receive one or more batteries that power one or more body components of the waste collection vehicle.

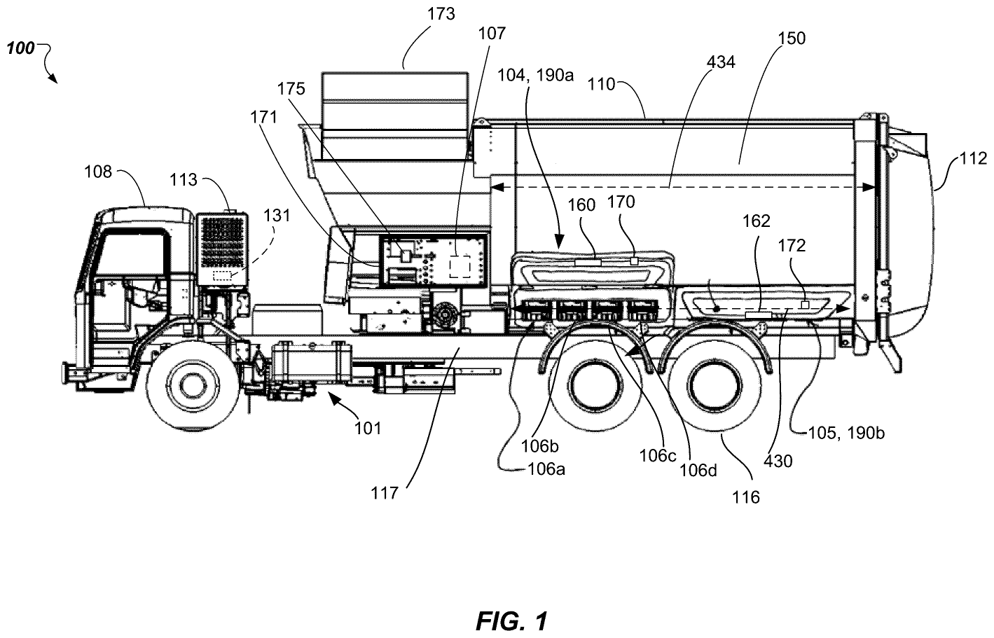

FIGS. 1-6 depict a refuse collection vehicle 100. The refuse collection vehicle 100 is illustrated as a rear loader, but the refuse collection vehicle 100 can be a front loader, a side loader, or another type of refuse collection vehicle such as a skid-loader, a tele-handler, a plow truck, or a boom lift.

The refuse collection vehicle 100 has a wheeled chassis 101. The wheeled chassis 101 includes a lower frame 117 and road wheels 116 attached to the lower frame 117. The refuse collection vehicle 100 also includes a cab 108 (e.g., a driver's cab), a refuse collection body 110 carried by the wheeled chassis 101, and a tailgate 112 coupled to the body 110. Propulsion of the chassis 101 of the refuse collection vehicle 100 can be powered by a variety of types of engines including, but not limited to, an electric engine, a diesel engine, or a compressed natural gas (CNG) engine. Referring to FIGS. 1, 2, and 4A, the refuse collection body 110 has an interior volume 109 between a pair of side walls 306, 310, one or more exterior surfaces of battery compartments 104, 105, 114, 115, a top surface 312 (e.g., roof), a floor panel 304 (also referred to herein as floor 304), and a front wall 314. The interior volume 109 includes a refuse storage compartment 111 that receives and stores refuse collected by the refuse collection vehicle 100. In addition, the interior volume 109 includes the battery compartments 104, 105, 114, 115, which will be described in further detail herein. Note that within this disclosure, we refer to the tailgate (e.g., tailgate 112) as a separate component from the body (e.g., body 110), such the interior volume of the tailgate is distinct from the interior volume of the body.

As will be described in further detail herein, the refuse collection vehicle 100 includes battery compartments 104, 105 for receiving one or more battery cells 106a-106e (collectively referred to as batteries cells 106 or batteries 106) that can be used to power one or more components of the refuse collection body 110. The refuse collection vehicle 100 can also include other components associated with electric vehicles such as a battery pack charger, an inverter, sensors, switches, and control systems such as an electric vehicle monitoring system (EVMS) and a battery management system (BMS) 602.

The refuse collection vehicle 100 can be fully electric. For example, the refuse collection vehicle 100 can have electric actuators (instead of hydraulic actuators) and one or more electric propulsion motors 118 connected to one or more wheels 116 of the chassis 101. The electric propulsion motors 118 can be configured, for example and without limitation, as hub motors, belt-drive motors, or mid-drive motors. The electric propulsion motors 118 can be, for example and without limitation, DC series motor, brushless DC motors, permanent magnet synchronous motors (PMSM), AC induction motors (e.g., three-phase AC induction motors), or switched reluctance motors (SRM). One or more battery packs can power the electric actuators and the propulsion motors 118. Additionally, the refuse collection vehicle 100 can have electric actuators but the propulsion can be non-electric (e.g., powered by a diesel or propane engine).

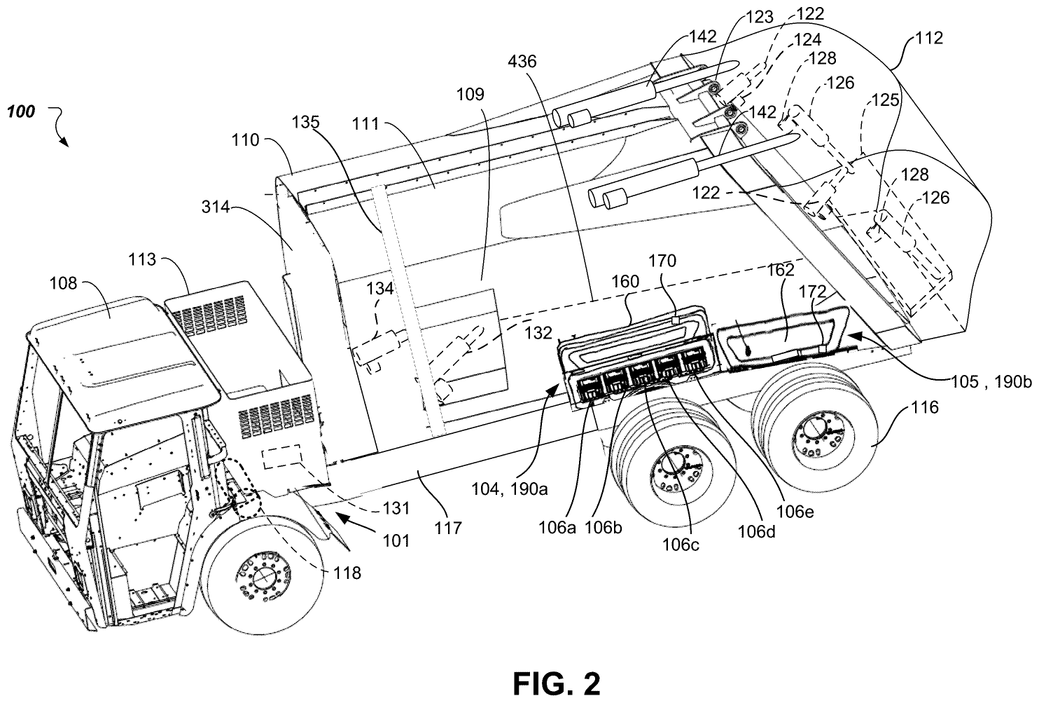

Referring to FIGS. 1 and 2, the refuse collection body 110 includes a powered tailgate 112 and a refuse packer 125. The powered tailgate 112 and the refuse packer 125 can be both driven by electric actuators. For example, the powered tailgate 112 is driven by one or more electric tailgate motors 124 of one or more electric actuators 122, and the refuse packer 125 is driven by one or more electric packer motors 128 of one or more electric actuators 126. Additionally, the refuse collection vehicle 100 can have other electrically-powered actuators in place of other typical hydraulic actuators. For example, the refuse collection vehicle 100 can have ejector electric actuators 134, body-raise electric actuators 132, and overhead container lift actuators 142. In the case of front-loader and side-loader vehicles, the arms or forks that lift the trash containers are also powered by electric motors and actuators. In some implementations, part of the body actuation functions could be electric and part could remain hydraulic. For example, instead of being driven by electric actuators 126, the tailgate 112 can be moved by hydraulic actuators. This could be accomplished with a local oil reservoir or with a larger oil reservoir that serving multiple hydraulic actuation points.

Referring to FIG. 2, each electric tailgate motor 124 is part of or is connected to a respective electric tailgate actuator 122 that is attached to the powered tailgate 112. For example, the electric tailgate motor 124 is attached (e.g., by a gearbox) to the electric tailgate actuator 122 to control, by rotation of a shaft of the motor 124, the electric tailgate actuator 122. The electric actuators 122, 126, 132, 134, 142 of the collection body 110 can be linear actuators or rotary actuators.

The electric tailgate actuator 122 can be, for example and without limitation, a ball screw actuator, a lead screw actuator, or a rotary style electric actuator. For example, the electric tailgate actuator 122 can be a linear actuator from Ewellix, located in Goteborg, Sweden. In the case of a linear actuator, the electric tailgate actuator 122 can push open, by extending an arm of the actuator 122, the powered tailgate 112. Extension of the actuator 122 causes the tailgate 112 to rotate about a pivot 123, opening the refuse storage compartment 111. Thus, the powered tailgate 112 is electrically opened and closed to unload the waste material stored in the refuse storage compartment 111.

Rotary actuator assemblies can include an electric motor that drives a gear reduction “box” which transmits power via a keyed or splined shaft to the electric tailgate or the corresponding component of the vehicle 100. The actuators 122, 126, 132, 134, 142 of the refuse collection body 110 can be custom-made for the specific power, force, speed, and displacement required to move the components of the collection body 110.

The electric tailgate motors 124 can be, for example and without limitation, a DC series motor, a brushless DC motor, a permanent magnet synchronous motor (PMSM), an AC induction motor (e.g., three-phase AC induction motors), or a switched reluctance motor (SRM).

Similar to the electric tailgate motors 124, each electric packer motor 128 is part of or is connected to a respective electric packer actuator 126. Each electric packer actuator 126 is attached to the refuse packer 125 to move the refuse packer 125. The electric packer motor 128 is attached (e.g., by a gearbox) to the electric packer actuator 126 and controls, by rotation of a shaft of the motor 128, the refuse packer 125. The electric packer actuators 126 move the packer 125 to pack the waste material by retracting (or extending) an arm of the actuator 126. The linear electric packer actuators 126 can be similar to the electric tailgate actuators 122 and the electric packer motors 128 can be similar to the electric tailgate motors 124.

The refuse collection vehicle 100 can also include a battery housing 113 that stores a chassis battery pack 131. The chassis battery pack 131 can include multiple battery cells (e.g., lithium-ion battery cells) that provide electrical power to the electric propulsion motors 118, to the electronic components of the chassis (e.g., headlights and tail lights) and to the electric components of the cab 108 (e.g., interior lights, navigation, air conditioning, radio, etc.).

Referring to FIGS. 1-6, the refuse collection vehicle 100 includes four battery compartments: two battery compartments 104, 105 located on the street-facing side 150 of the vehicle 100 and two battery compartments 114, 115 located on the curb-facing side 152 of the vehicle 500. Each battery compartment 104, 105, 114, 115 is configured house five battery cells 106 (e.g., lithium-ion battery cells) that can provide electrical power to all or part of the electrical components of the refuse collection vehicle 100. For example, the battery cells 106 in the battery compartments 104, 105, 114, 115 can provide electrical power to one or more of the propulsion motors 118, the electric tailgate motors 124, the electric packer motors 128, the electric motors of the other electric actuators 132, 134, and 142, and to the electrical components inside the cab 108 of the vehicle 100.

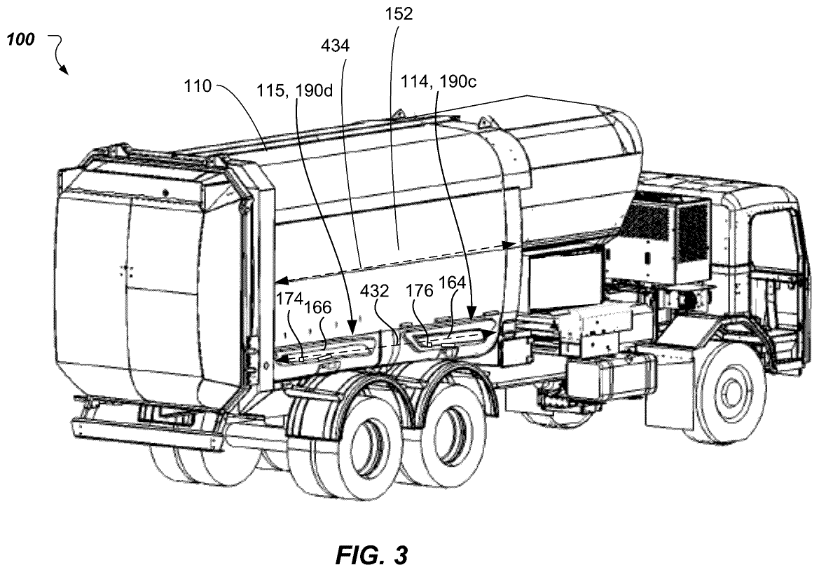

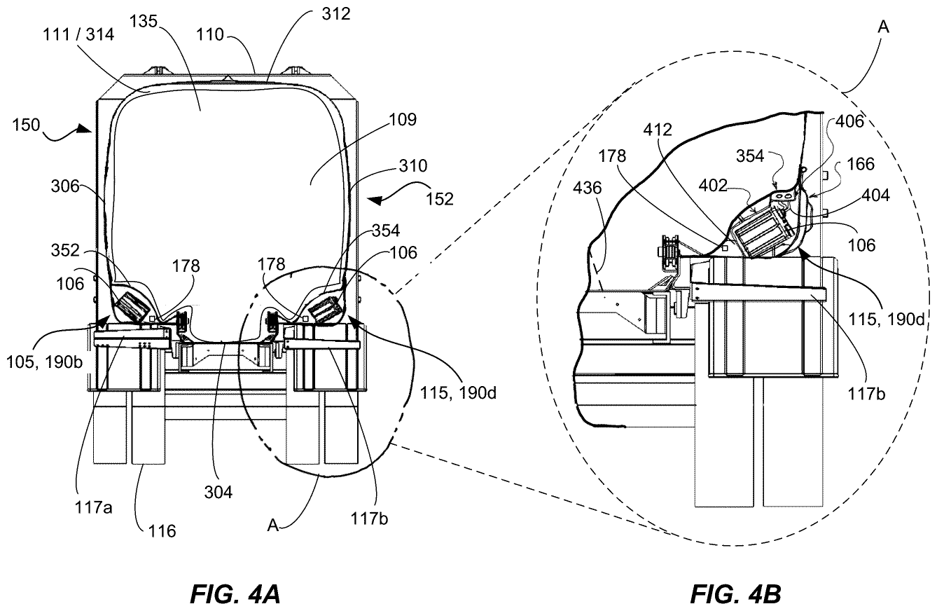

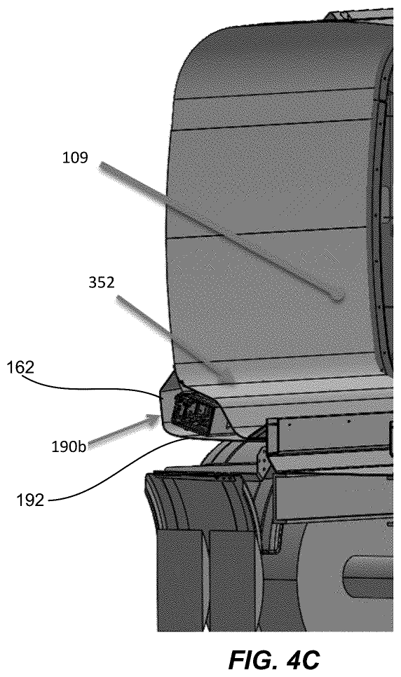

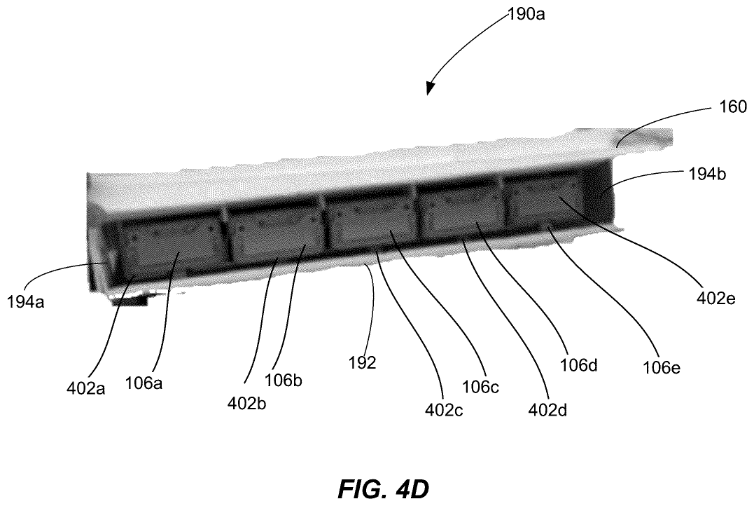

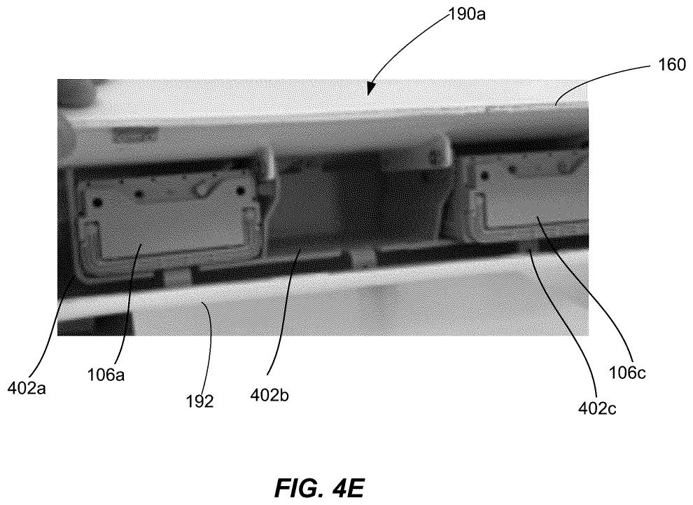

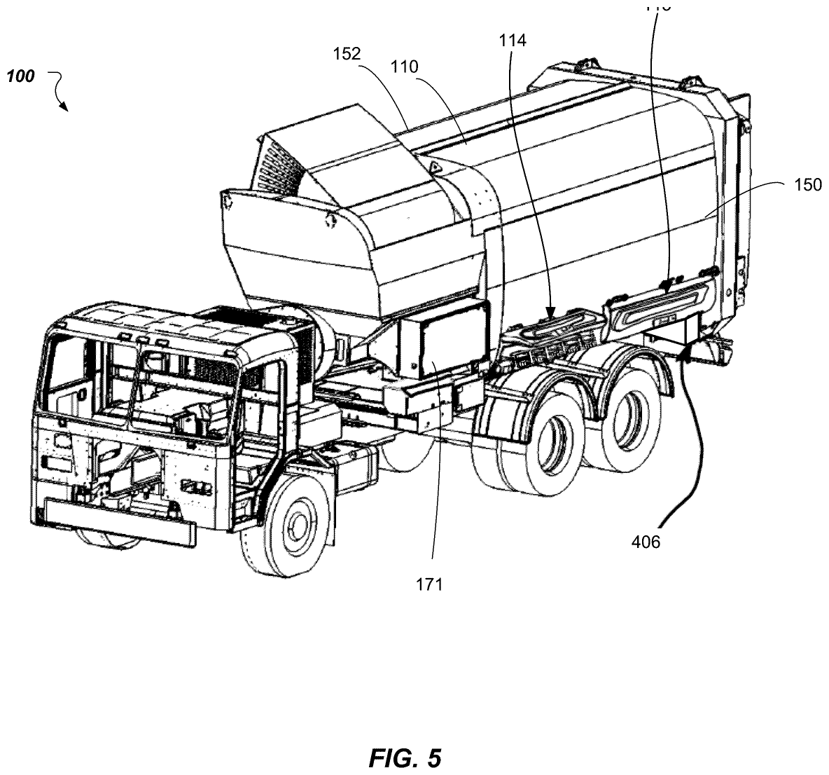

As can be seen in FIG. 4A, the battery compartments 104, 105, 114, 115 are each positioned within the interior volume 109 of the body 110 of the vehicle 100 over the frame rails 117a, 117b of the chassis 101. In particular, the street-side battery compartments 104, 105 are positioned within the interior volume 109 above the street-side frame rail 117a of the chassis 101 and the curb-side battery compartments 114, 115 are positioned within the interior volume 109 above the curb-side frame rail 117b of the chassis 101. In addition, as can be seen in FIGS. 1 and 3, the longitudinal axis 430, 432 of each of the battery compartments 104, 105, 114, 115 is aligned with the longitudinal axis 434 of the body 110 of the vehicle 100. In some implementations, the longitudinal axis 430, 432 of each of the battery compartments 104, 105, 114, 115 is parallel with the longitudinal axis 434 of the body 110 of the vehicle 100.

Positioning the battery cells 106 within an interior volume 109 of the body 110 of the refuse collection vehicle 100 can provide several possible advantages. For example, in some implementations, positioning battery cells 106 within the interior volume 109 of the body 110 reduces the risk of damage to the battery cells 106 resulting from an impact to the vehicle (e.g., during a collision with vehicle or with another object, such as a tree limb). In some implementations, by positioning the battery cells 106 in battery compartments 104, 105, 114, 115 positioned along the body 110 of the refuse collection vehicle 100 and over the frame rails 117a, 117b of the chassis 101, can improve distribution of the weight of the battery cells 106, which can improve the stability of the refuse collection vehicle 100. In some implementations, by coupling the cells 106 to the body 110 of the vehicle 100, rather than to the cab 108 or to the chassis 101, various different types of chasses and cabs can be used together with the body 110 of the refuse collection vehicle 100 without requiring design alterations to the cab 108 or chassis 101. In some implementations, positioning the battery cells 106 within the interior volume 109 of the body 110, rather than on the cab 108 or chassis 101, increases the amount of available space within the cab 108 and on the chassis 101.

As can be seen in FIGS. 4A and 4C, the floor panel 304 of the body 110 of the vehicle 100 includes two curved portions 352, 354 that extend along the longitudinal axis 434 of the body 110 over the frame rails 117a, 117b. The curved portions 352, 354 of the floor panel 304 that curve inwards towards a center of the refuse storage compartment 111 to define a space within the interior volume 109 of the body 110 corresponding to the respective battery compartments 104, 105, 114, 115. In some implementations, each battery compartment 104, 105, 114, 115 has a volume up to 0.22 cubic feet. In some implementations, each battery compartment 104, 105, 114, 115 has a volume of 0.11 cubic feet. In some implementations, the combined volume of the battery compartments 104, 105, 114, 115 accounts for 0.44 cubic feet of the total volume of the interior volume 109 of the vehicle 100.

The curved portions 352, 354 of the floor panel 304 separate the battery compartments 104, 105, 114, 115 from the refuse storage compartment 111 and prevent any solids or liquids contained within the refuse storage compartment 111 from entering the battery compartments 104, 105, 114, 115. The curved portions 352, 354 of the floor panel 304 are configured to support the weight of refuse that is positioned within the body over the battery compartments 104, 105, 114, 115 and to distribute the load of the refuse to the side walls 306, 310 and frame rails 117a, 117b of the vehicle 100.

As can be seen in FIGS. 1-4E, each of the battery compartments 104, 105, 114, 115 includes an enclosure 190a, 190b, 190c, 190d (collectively referred to as enclosures 190 herein) that encloses the battery cells 106 and protects the battery cells 106 from from the external environment. As can be seen in FIGS. 4D and 4E, each enclosure 190 includes a base portion 192 that extends beneath the battery cells within the respective battery compartment 104, 105, 114, 115, side portions 194a, 194b extending from the base portion 192 (collectively referred to as side portions 194 herein), and a hinged cover panel 160, 162, 164, 166. In some implementations, the enclosures 190 are formed of a vacuum-formed polymer material. Each of the enclosures 190 is coupled to the body 110 of the vehicle 100. For example, the base portion 192 of each enclosure 190 can be welded, screwed, bolted, or otherwise attached to an exterior surface of the floor panel 304 of the body 110. In some implementations, a side portion 194 of each of the enclosures 190a, 190b of the street-side battery compartments 104, 105 are attached to one another and a side portion 194 of each of the enclosures 190c, 190d of the curb-side battery compartments 114, 115 are attached to each other (e.g., by bolting or screwing adjacent side portions 194 of the enclosures 190 together).

Each of the exterior cover panels 160, 162, 164, 166 is coupled to an exterior surface of a respective enclosure 190 and can be raised and lowered in order to provide access to and protect the battery cells 106 within the respective enclosures 190. In some implementations, each of the exterior cover panels 160, 162, 164, 166 is coupled to the respective enclosure 190 using a pinned or hinged connection and rotates about the pinned or hinged connection between an open position (i.e., a raised position) and closed position (i.e., a lowered position). For example, as depicted in FIG. 1 exterior cover panel 160 is raised to expose the battery cells 106 contained within the enclosure 190a of the battery compartment 104, respectively and exterior cover panels 162, 164, 166 are in the lowered position to cover enclosures 190b, 190c, 190d of battery compartments 105, 114, 115, respectively. In some implementations, the exterior cover panels 160, 162, 164, 166 enable an operator to access the battery cells 106 from the exterior of body 110 of the refuse collection vehicle 100. For example, an operator can raise an exterior cover panel 160, 162, 164, 166 in order to access the battery cells 106 contained within the respective battery compartment 104, 105, 114, 115, for example, to remove or replace one or more of the battery cells 106 contained within the battery compartment 104, 105, 114, 115. When in the lowered position, the exterior cover panels 160, 162, 164, 166, together with the base portion 192 and side panels 194 of the respective enclosure 190, prevent contact between the battery cells 106 contained within the battery compartments 104, 105, 114, 115 and objects outside the vehicle 100. In some embodiments, each of the exterior cover panels 160, 162, 164, 166 includes an elastomeric seal to prevent moisture from entering the respective battery compartments 104, 105, 114, 115.

In some implementations, each of the exterior cover panels 160, 162, 164, 166 includes an upper panel and a lower panel that can be individually opened in order to expose an upper portion of the respective battery compartment 104, 105, 114, 115 and a lower portion of the respective battery compartment 104, 105, 114, 115, respectively. For example, each exterior cover panel 160, 162, 164, 166 can include (i) an upper panel that is rotatable about a first hinge and can be opened (e.g., raised) to access the battery cells 106 contained within the respective battery compartment 104, 105, 114, 115 and (ii) a lower panel that is rotatable about a second hinge and can be opened (e.g., lowered) to access cabling that is located within the respective battery compartment 104, 105, 114, 115.

In some implementations, the exterior cover panels 160, 162, 164, 166 each include a locking mechanism 170, 172, 174, 176 that prevents movement of the exterior cover panels 160, 162, 164, 166 from the closed position into an open position when the respective locking mechanism 170, 172, 174, 176 is engaged. In some implementations, the locking mechanism 170, 172, 174, 176 is an electric interlock that communicates with a controller 107 of the vehicle 100 to automatically lock and unlock the exterior cover panels 160, 162, 164, 166. For example, in response to the controller 107 receiving signals from one or more sensors indicating that the vehicle 100 is in motion, the controller 107 can cause the locking mechanisms 170, 172, 174, 176 to engage to lock the exterior cover panels 160, 162, 164, 166 cover panels in the closed (e.g., lowered) position. In some implementations, in response to the controller 107 receiving signals from one or more sensors indicating that power is being output by one or more battery cells 106 within a particular battery compartment 104, 105, 114, 115, the controller 107 can cause the respective locking mechanism 170, 172, 174, 176 to lock the respective exterior cover panel 160, 162, 164, 166 in the closed position in order to prevent electrical shocks to persons or animals proximate the vehicle 100 while the battery cell(s) 106 are outputting power. In some implementations, the controller 107 can cause the respective locking mechanisms 170, 172, 174, 176 to unlock an exterior cover panel 160, 162, 164, 166 in response to receiving signals from one or more sensors indicating that none of the battery cells 106 contained within the respective battery compartment 104, 105, 114, 115 are outputting power. In some implementations, an operator of the vehicle can lock and unlock each of the locking mechanisms 170, 172, 174, 176 using, for example, a physical key or an electronic switch within the cab 108 of the vehicle 100.

Referring to FIGS. 4B, 4D, and 4E, each of the battery compartments 104, 105, 114, 115 includes one or more support structures 402a-402e (collectively referred to as support structures 402 herein) for supporting and positioning the battery cells 106 within the respective battery compartments 104, 105, 114, 115. In some implementations, the support structure 402 is a single U-shaped configured to support all of the battery cells 106 contained within the respective battery compartment 104, 105, 114, 115. In some implementations, the support structure includes multiple brackets, and each battery cell 106 within a particular battery compartment 104, 105, 114, 115 is positioned within and supported by a respective bracket of the support structure 402. In some implementations, the battery cells 106 are removably coupled to the respective support structure 402. As can be seen in FIG. 4E, in some implementations, the support structure(s) 402 are coupled to the respective enclosure 190 The support structures 402 can be mechanically coupled to one or more interior surfaces of the respective battery compartment 104, 105, 114, 115 using any suitable means, including but not limited to, bolting, screwing, or welding the support structures 402 to one or more interior surfaces of the respective enclosure 190. In some implementations, as depicted in FIG. 4B, the support structures 402 are attached to the panel 302, 308 that is separating the respective battery compartment 104, 105, 114, 115 from the refuse storage compartment 111.

In some implementations, the enclosures 190 of the battery compartments 104, 105, 114, 115 are removably coupled to the body 110 of the vehicle 100, and the battery cells 106 can be positioned on the support structures 402 within each enclosure 190 prior to attaching the respective enclosure 190 to the body 110 of the vehicle 100. In some implementations, the battery cells 106 are secured to the respective support structure 402 and respective enclosure 190 by passing a tie down strap over the battery cells 106 and around the respective support structure 402.

As can be seen in FIGS. 4B and 4C, the support structures 402 are each angled downwards (e.g., between 1°-89° relative to a horizontal plane) towards the center line 436 of the interior volume 109 in order to angle the battery cell(s) 106 that are positioned on the support structure 402 downwards. By angling the battery cells 106 downwards towards center line 436 of the interior volume 109, part of the weight of the battery cells 106 is directed inwards towards the center of the interior volume 109 and towards a rear surface 412 of the support structures 402 when the refuse collection vehicle 100 turns, which serves to reduce or prevent movement and/or disconnection of the battery cells 106 while the vehicle 100 is in motion.

Referring to FIGS. 4A and 4B, in some implementations, each battery compartment 104, 105, 114, 115 includes one or more sensors 178 configured to detect one or more conditions of the battery cells 106 within the respective battery compartment 104, 105, 114, 115, including, but not limited to, the voltage, temperature, and charging level of each battery cell 106 contained within the respective battery compartment 104, 105, 114, 115. In some implementation, the refuse collection vehicle 100 includes a Controller Area Network (CAN) bus that connects the various sensors with an onboard computing device (e.g., controller 107). For example, the one or more sensors 178 can be configured to detect a thermal event, such as a fire, occurring in a particular battery compartment 104, 105, 114, 115, and send a signal indicating that the thermal event is occurring in the respective battery compartment 104, 105, 114 to an onboard computing device, In response, the onboard computing device can transmit a warning to the operator of the vehicle 100 (e.g., using a visual or auditory indicator within the cab 108) to indicate that a thermal event is occurring in the respective battery compartment 104, 105, 114, 115. In some implementations, the sensors 178 digitize the signals that communicate the sensor data before sending the signals to the onboard computing device, if the signals are not already in a digital format.

In some implementations, one or more of the interior surfaces of each of the battery compartments 104, 105, 114, 115 is formed of or covered with a fire suppression material. In some implementations, the interior surface of each of the enclosures 190 is formed of or covered with a fire suppression material. The fire suppression material inside the battery compartments 104, 105, 114, 115 reduces the transfer of heat from the interior of the battery compartments 104, 105, 114, 115 to the floor panel 304 or side walls 306, 310 and the interior volume 109 of the vehicle 100. In some implementations, one or more infrared cameras are installed in each battery compartment 104, 105, 114, 115 to detect any thermal events occurring within the respective battery compartment 104, 105, 114, 115. In some implementations, each exterior cover panel 160, 162, 164, 166 includes a visual indicator 180, 182, 184, 186, such as a LED light(s), indicating that a thermal event is occurring within the respective battery compartment 104, 105, 114, 115 (e.g., as detected by sensor(s) 178 within the respective battery compartment 104, 105, 114, 115).

Referring to FIGS. 4B, each of the battery cells 106 is electrically coupled to the controller 107 by cabling 404 that is attached to each battery cell 106. In some implementations, the cabling 404 coupling the battery cells 106 to the battery compartments 104, 105, 114, 115 includes a quick release mechanism that allows an operator to easily release an individual battery cell 106 from the respective battery compartment 104, 105, 114, 115 in order to, for example, replace a particular battery cell 106 without having to replace other functioning battery cells within the respective battery compartment 104, 105, 114, 115. In some implementations, the quick release mechanism that couples the battery cells 106 to the battery compartments 104, 105, 114, 115 allows an operator to remove and replace the battery cells 106 by hand without the use of special tools.

As previously discussed, the battery cells 106 in the battery compartments 104, 105, 114, 115 can be used to power various body components of the refuse collection vehicle, including, but not limited to, the electric actuators 122, 126, 132, 134, 142 of the refuse collection body 110. In some implementations, each of the battery cells 106 is electrically coupled to the controller 107 through the cabling 404, and the controller 107 distributes the power output by the battery cells 106 to one or more components of the body 110 of the refuse collection vehicle 100. In some implementations, the controller 107 includes a battery management system (BMS) 602 that can be used to manage and monitor battery function and safety controls of the battery cells 106 within each of the battery compartments 104, 105, 114, 115.

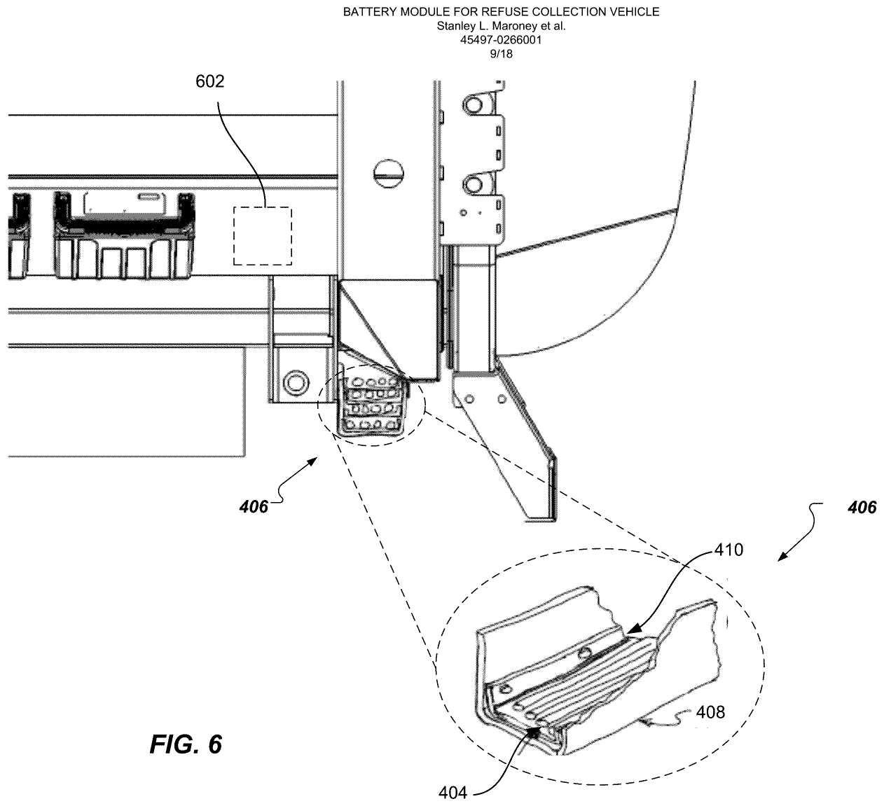

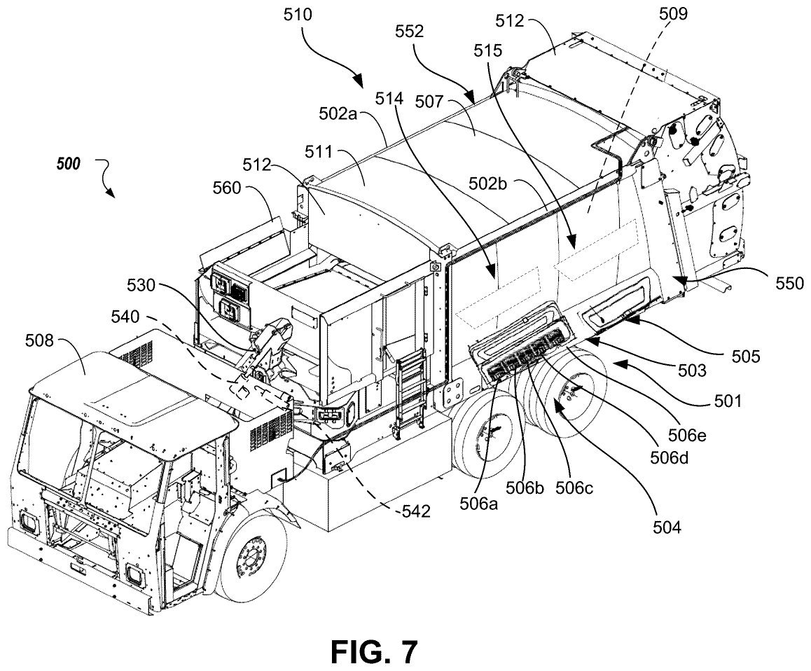

In some embodiments, the cabling 404 electrically couples the battery cells 106 contained within the street-side battery compartments 104, 105 to the battery cells 106 contained within the curb-side battery compartments 114, 115. Referring to FIGS. 5 and 6, the vehicle 100 includes a cross-over tray 406 that extends underneath the body 110 of the vehicle 100 proximate the tailgate 112 of the vehicle 100 and supports the cabling 404 that from one or more battery cells 106 within battery compartments 104, 105 114, 115 to the BMS 602. For example, the five battery cells 106 within each battery compartment are wired in series with one another, and one battery cell 106 from each battery compartment 104, 105, 114, 115 is wired in parallel to the BMS 602 via cabling 404 that extends from the respective battery cell 106 through the crossover tray 406 to the BMS 602. As a result, the battery cells 106 contained within each of the battery compartments 104, 105, 114, 115 can be monitored and controlled by the BMS 602.

The cross-over tray 406 includes an outer support 408 that supports the weight of the cabling 404 and protects the cabling from the environment outside the vehicle 100. The outer support 408 can be formed of any suitable material (e.g., steel or another suitable metal). The cross-over tray 406 also includes a plurality of inner supports 410 that are coupled to the outer support 408 and are configured to arrange and organize the cabling 404 within the cross-over tray 406.

Referring back to FIG. 1, in some implementations, the controller 107 of the vehicle includes a control panel 171. In some implementations, the vehicle 100 also includes a cover 173 that is rotatably coupled (e.g., using one or more hinge attachments) to the outer surface of the body 110 and configured to be raised and lowered between an open position and a closed position. The control panel 171 is covered and protected by the cover 173 when the cover 173 is lowered into the closed position, and an operator can raise the cover 173 into the open position in order to access the control panel 171.

In some implementations, the control panel 171 includes a charging port 175 that can be used to charge the battery cells 106 contained within the battery compartments 104, 105, 114, 115 and the chassis battery pack 131. The charging port 175 enables the battery cells 106 to be charged without removing the battery cells 106 from the respective battery compartments 104, 105, 114, 115. In some implementations, the battery cells 106 and the chassis battery pack 131 are charged using an onboard generator that can charge the battery cells 106 and chassis battery pack 131 while the vehicle 100 is in motion.

The battery compartments 104, 105, 114, 115 can have or can be coupled to a cooling system (e.g., a direct or indirect liquid cooling system) that keeps the battery cells 106 from overheating. Additionally, the electric actuators 122, 126, 132, 134, 142 (e.g., the actuator motors) of the vehicle 100 can include a dedicated cooling system or be integrated into the cooling system of the battery compartments 104, 105, 114, 115. For example, the vehicle 100 can use heat sinks and/or can have air conduits to route air to the battery compartments 104, 105, 114, 115 and the electric actuators 122, 126, 132, 134, 142. In some implementations, each battery compartment 104, 105, 114, 115 includes one or more air cooling vents to help regulate the temperature within the battery compartments 104, 105, 114, 115. In some implementations, the air cooling vents within each of the battery compartments 104, 105, 114, 115 is used to automatically regulate the temperature within the battery compartments 104, 105, 114, 115. For example, when the ambient temperature outside the vehicle 100 is low, the air vents within the battery compartments 104, 105, 114, 115 would automatically close to retain heat within the battery compartments 104, 105, 114, 115, and when the ambient temperature outside the vehicle 100 is high, the air vents within the battery compartments 104, 105, 114, 115 would automatically open to introduce fresh air flow into the battery compartments 104, 105, 114, 115 in order to reduce the temperature within the battery compartments 104, 105, 114, 115.

Further, as can be seen in FIGS. 2 and 4A, the refuse collection vehicle 100 includes an ejector panel 135 that is positioned within the refuse storage compartment 111 and is mechanically coupled to the ejector electric actuator(s) 134. The ejector panel 135 is configured to move longitudinally within the refuse storage compartment 111 to eject refuse from the refuse storage compartment 111. The profile of the ejector panel 135 is shaped to contact the side walls 306, 310, the top surface 312, and the floor panel 304 as the ejector panel 135 moves longitudinally within the refuse storage compartment 111.

While certain embodiments have been described, other embodiments are possible.

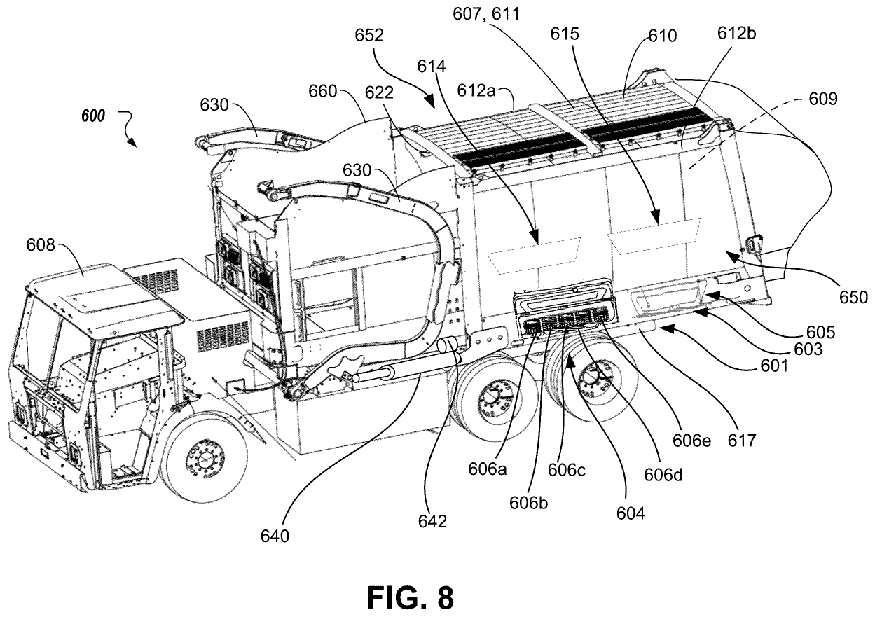

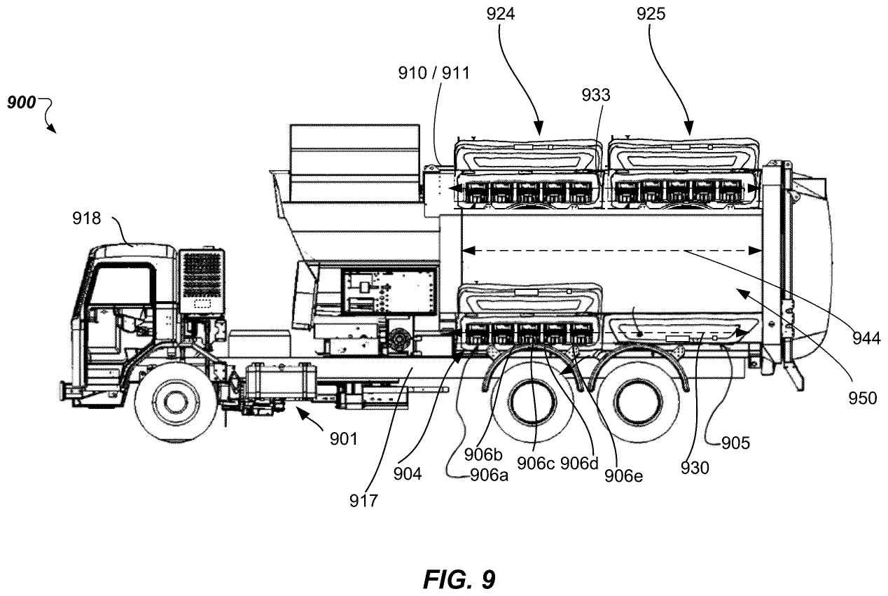

For example, while the battery compartments 104, 105, 114, 115 have been described as being part of a rear-loader refuse collection vehicle 100, the battery compartments can be provided on other types of refuse collection vehicles, such as side-loader refuse collection vehicles, as depicted in FIG. 7, and front-loader refuse collection vehicles, as depicted in FIG. 8.

FIG. 7 shows a side-loader refuse collection vehicle 500. The body 510 of the refuse collection vehicle 500 defines an interior volume 509 that, similarly to interior volume 109 of FIGS. 1-4B, is enclosed between a pair of side walls 502a, 502b, a top surface (e.g., roof) 507, a floor 503, and a front wall 512. The interior volume 509 of the vehicle 500 includes a refuse storage compartment 511 that receives and stores refuse collected by the refuse collection vehicle 500. The side-loader refuse collection vehicle 500 has a robotic arm 530 that is moved by electric actuators 540, 542. The electric actuators can include, for example, an arm lift electric actuator 540 and an arm reach electric actuator 542. Each electric actuator 540, 542 can be moved, similarly to the electric actuators 122, 126, 132, 134, 142 of FIG. 2, by a respective electric motor that is coupled to the actuators 540, 542 and that is powered by the battery cells 106 contained within one or more battery compartments 504, 505, 514, 515. The robotic arm 530 can dump the waste material inside a hopper 560 disposed between the refuse storage compartment 511 and the cabin 508 of the refuse collection vehicle 500.

Similar to the refuse collection vehicle 100 described in FIGS. 1-6, the side-loader refuse collection vehicle 500 has two battery compartments 504, 505 located on the street-facing side 550 of the body 510 of the vehicle 500 and two battery compartments 514, 515 located on the curb-facing side 552 of the body 510 of the vehicle 500. Each battery compartment 504, 505, 514, 515 is configured house multiple battery cells 506a-506e (collectively referred to as batteries cells 506 or batteries 506) that can provide electrical power to all or part of the electrical components of the refuse collection vehicle 500, including the arm lift electric actuator 540 and an arm reach electric actuator 542. Similar to the battery compartments 104, 105, 114, 115 of the vehicle 100 of FIG. 1-6, the battery compartments 504, 505, 514, 515 of the side-loader refuse collection vehicle 500 are each positioned within the interior volume 509 of the body 510 of the vehicle 500 over the frame rails of the chassis 501 of the vehicle 500 and the floor 503 of the body 510 of the vehicle 500 separates the battery compartments 504, 505, 514, 515 from the refuse storage compartment 511 of the vehicle 600.

FIG. 8 shows a front-loader refuse collection vehicle 600. The refuse collection body 610 defines an interior volume 609 that, similarly to interior volume 109 of FIGS. 1-4B, is enclosed between a pair of side walls 612a, 612b, a top surface (e.g., roof) 607, a floor 603, and a front wall 6222. The interior volume 109 includes a refuse storage compartment 611 that receives and stores refuse collected by the refuse collection vehicle 600. The front-loader refuse collection vehicle 600 has two robotic arms 630 (or lifts 630). Each arm 630 is moved by a respective electric actuators 640. Each electric actuator 640 is moved, similarly to the electric actuators 122, 126, 132, 134, 142 of FIG. 2, by a respective electric motor 642 that is coupled to the actuator 640 and that is powered by the battery cells 606 contained within one or more battery compartments 604, 605, 614, 615. The arms 630 lift a waste container and dump the waste material from the container into a hopper 660 disposed between the storage compartment 611 and the cabin 608 of the refuse collection vehicle 600.

Similar to the refuse collection vehicles 100, 500 described in FIGS. 1-7, the front-loader refuse collection vehicle 600 has two battery compartments 604, 605 located on the street-facing side 650 of the body 610 of the vehicle 600 and two battery compartments 614, 615 located on the curb-facing side 652 of the body 610 of the vehicle 600. Each battery compartment 604, 605, 614, 615 is configured house multiple battery cells 606a-606e (collectively referred to as batteries cells 606 or batteries 606) that can provide electrical power to all or part of the electrical components of the refuse collection vehicle 600, including the electric actuator 640 that moves the arms 630. Similar to the battery compartments 104, 105, 114, 115 of the vehicle 100 of FIG. 1-3, the battery compartments 604, 605, 614, 615 of the front-loader refuse collection vehicle 600 are each positioned within the interior volume 609 of the body 610 over the frame rails 617 of the chassis 601 of the vehicle 600 and the floor 603 of the body 610 of the vehicle 600 separates the battery compartments 604, 605, 614, 615 from the refuse storage compartment 611 of the vehicle 600.

While the battery compartments 104, 105, 114, 115, 504, 505, 514, 515, 604, 605, 614, 615 have each been described as housing five battery cells 106, the battery compartments 104, 105, 114, 115, 504, 505, 514, 515, 604, 605, 614, 615 can house other numbers of battery cells 106 (e.g., 1, 2, 3, 4, 6, etc.). In addition, while the refuse collection vehicles 100, 500, 600 have each been described as having four battery compartments 104, 105, 114, 115, 504, 505, 514, 515, 604, 605, 614, 615, the refuse collection vehicles can have other numbers of battery compartments 104, 105, 114, 115, 504, 505, 514, 515, 604, 605, 614, 615 (e.g., 1, 2, 3, 5, 6, etc.). Further, while the battery compartments 104, 105, 114, 115, 504, 505, 514, 515, 604, 605, 614, 615 have each been described as being positioned within the interior volume 109, 509, 609 of the vehicle 100, 500, 600 beneath the floor 304, 503, 603 of the vehicle 100, 500, 600 and above a respective frame rail 117, 617, one or more of the battery compartments can be positioned at other locations within the interior volume of the vehicle.

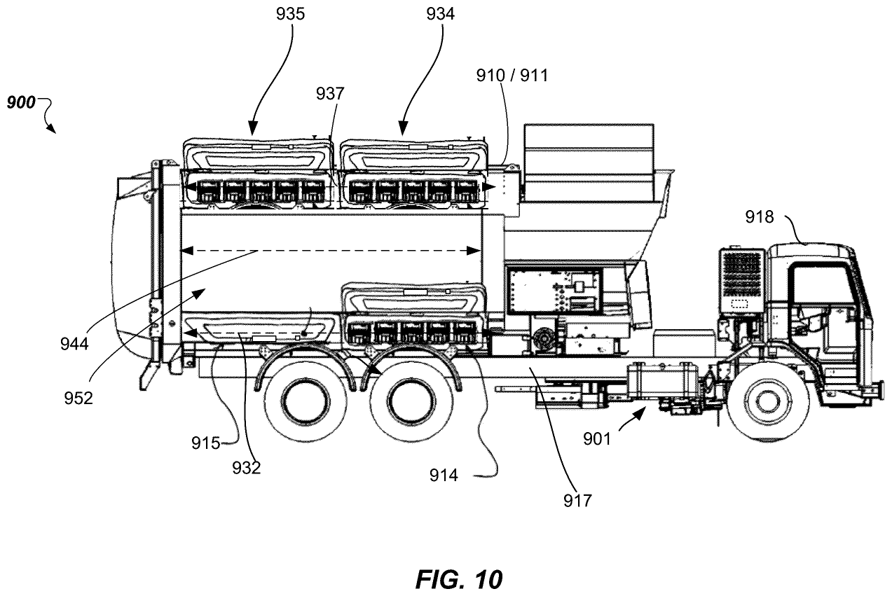

For example, FIGS. 9-11 shows a rear-loader refuse collection vehicle 900 with eight battery compartments 904, 905, 914, 915, 924, 925, 934, 935. In particular, the refuse collection vehicle 900 includes four battery compartments 904, 905, 924, 925 that are positioned on the street-facing side 950 of the vehicle 900 and four corresponding battery compartments 914, 915, 934, 935 that are positioned on the curb-facing side 952 of the vehicle 900. Each battery compartment 904, 905, 914, 915, 924, 925, 934, 935 is configured house five battery cells 906a-906e (e.g., lithium-ion battery cells, collectively referred to herein as battery cells 906 or batteries 906) that can provide electrical power to all or part of the electrical components of the refuse collection vehicle 900, including one or more propulsion motors, electric tailgate motors, electric packer motors, electric motors of the other electric actuators, and electrical components inside the cabin 918. The structure and components of the interior of each of the battery compartments 904, 905, 914, 915, 924, 925, 934, 935 is substantially similar to the interior of the battery components 104, 105, 114, 115 depicted in FIGS. 1-6.

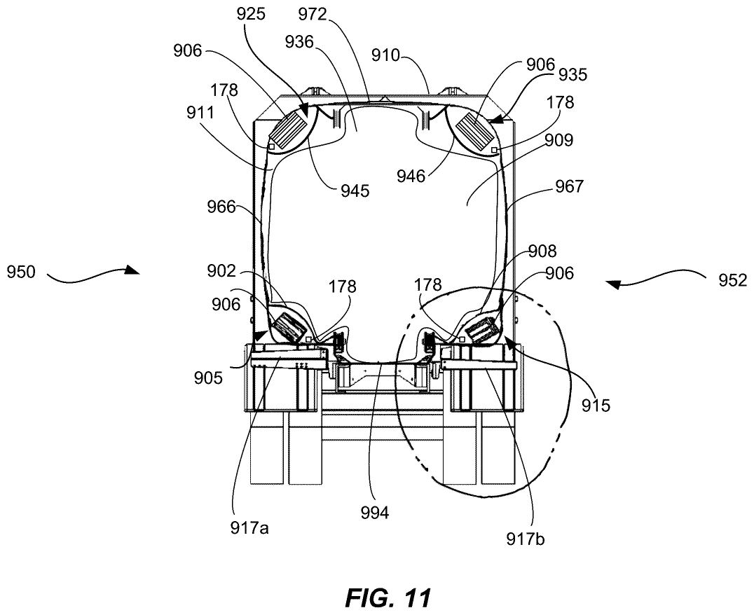

As can be seen in FIG. 11, the battery compartments 904, 905, 914, 915, 924, 925, 934, 935 are each positioned within the interior volume 909 of the body 910 of the vehicle 900 above the floor 994 of the interior volume 909 and are each positioned over a frame rail 917 of the chassis 901. Two of the street-side battery compartments 904, 905 are positioned within the interior volume 909 above the street-side frame rail 917a of the chassis 901 beneath the floor 994 of the interior volume 90 and the other two street-side battery compartments 924, 925 are positioned within the interior volume 909 above the street-side frame rail 917a of the chassis 901 proximate the top surface 972 (e.g., roof) of the interior volume 909. Similarly, two of the curb-side battery compartments 914, 915 are positioned within the interior volume 909 above the curb-side frame rail 917b of the chassis 101 proximate the floor 994 of the interior volume 909, and the other two curb-side battery compartments 934, 935 are positioned within the interior volume 909 above the curb-side frame rail 917b of the chassis 101 proximate the top surface 972 of the interior volume 909. In addition, as can be seen in FIGS. 9 and 10, the longitudinal axis 930, 932, 933, 937 of each of the battery compartments 904, 905, 914, 915, 924, 925, 934, 935 is aligned with the longitudinal axis 944 of the body 910 of the vehicle 900. In some implementations the longitudinal axis 930, 932, 933, 937 of each of the battery compartments 904, 905, 914, 915, 924, 925, 934, 935 is parallel with the longitudinal axis 944 of the body 910 of the vehicle 900.

Similar to battery compartments 104, 105, 114, 115 of FIGS. 1-4E, battery compartments 904, 905, 914, 915 are separated from the refuse storage compartment 911 by curved portions 902, 908 of the floor panel 994. Similar to curved portion 352, 354 of FIGS. 4A and 4B, the curved portions 902, 908 of the floor panel 994 separating the battery compartments 904, 905, 914, 915 from the refuse storage compartment 911 are curved inwards towards a center of the refuse storage compartment 911 in order to define a space corresponding to the battery compartments 904, 905, 914, 915 within the interior volume 909 of the body 910 of the vehicle 900. The floor panel 994 prevents any solids or liquids contained within the refuse storage compartment 911 from entering the battery compartments 904, 905, 914, 915.

In addition, battery compartments 924, 925, 934, 935 are separated from the refuse storage compartment 911 by curved portions 945, 946 of the top surface 972 of the interior volume 909. The curved portions 945, 946 of the top surface 972 separating the battery compartments 924, 925, 934, 935 from the refuse storage compartment 911 are curved inwards towards a center of the refuse storage compartment 911 in order to define a space corresponding to the battery compartments 924, 925, 934, 935 within the interior volume 909 of the body 910 of the vehicle 900. The top surface 972 prevents any solids or liquids contained within the refuse storage compartment 911 from entering the battery compartments 924, 925, 934, 935.

Similar to the vehicle 100 depicted in FIGS. 1-6, the refuse collection vehicle 900 includes an ejector panel 936 that is positioned within the refuse storage compartment 911 and that is mechanically coupled to an ejector electric actuator(s) (e.g., similar to ejector electric actuator 134 of FIG. 2). The profile of the ejector panel 936 is shaped to contact the side walls 966, 967, the top surface 972, and the floor 994 as the ejector panel 936 moves longitudinally within the refuse storage compartment 911 to eject refuse from the refuse storage compartment 911.

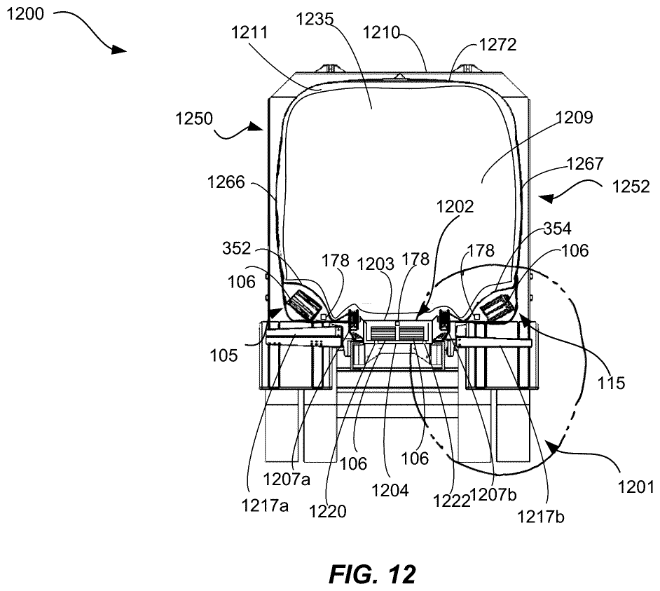

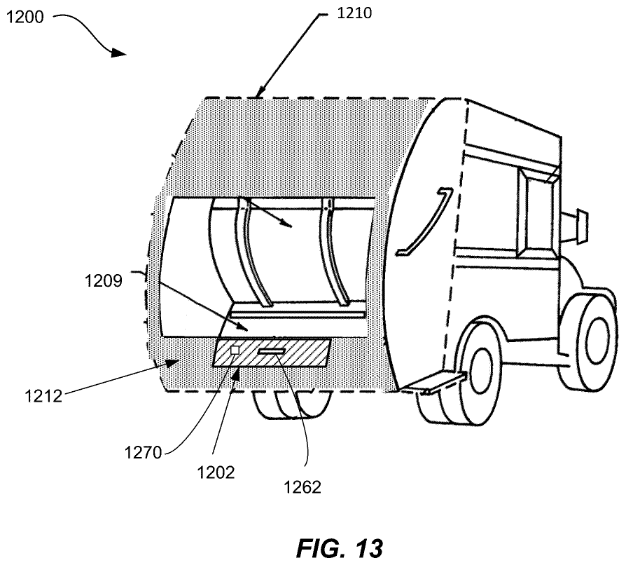

FIGS. 12 and 13 show another example rear-loader refuse collection vehicle 1200. Refuse collection vehicle 1200 includes a center battery compartment 1202 in addition to the battery compartments 104, 105, 114, 115 positioned above the frame rails 1217a, 1217b of the chassis 1201 of the vehicle, which are described in detail in reference to FIGS. 1-6. As depicted in FIG. 12, the center battery compartment 1202 is positioned within an interior volume 1209 of the body 1210 of the vehicle 1200 above the floor 1204 of the interior volume 1209 and between the frame rails 1217a, 1217b of the chassis 1201 of the vehicle 1200. In some implementations, the center battery compartment 1202 is positioned within the interior volume 1209 of the vehicle between a pair of chain rails 1207a, 1207b along which an ejector panel 1235 travels through the interior volume 1209, as depicted in FIG. 12. The center battery compartment 1202 is configured to house one or more battery cells 106. Similar to battery compartments 104, 105, 114, 115 described in reference to FIGS. 1-8, the center battery compartment 1202 can include a support structure (e.g., similar to support structure 402 of FIG. 4B) to support the battery cells 106 contained within the center battery compartment 1202. In addition, the battery cells 106 contained within the center battery compartment 1202 can be mechanically coupled to the center battery compartment 1202 and electrically coupled to a controller of the vehicle (e.g., controller 107 of FIG. 1) by cabling that is attached to each battery cell 106 (e.g., similar to cabling 404 of FIG. 4B).

The center battery compartment 1202 is separated from the refuse storage compartment 1211 by a floor panel 1203 of the vehicle 1200. The floor panel 1203 can form a liquid tight barrier between the refuse storage compartment 1211 and the center battery compartment 1202 to prevent any solid or liquid refuse from entering the center battery compartment 1202 from the refuse storage compartment 1211. In some implementations, the floor panel 1203 is welded to the side walls 1266, 1267 or the floor 1204 of the interior volume 1209 of the vehicle 1200.

The center battery compartment 1202 is slidably coupled to the body 1210 of the vehicle 1200 along a pair of rails 1220, 1222 that are formed on the floor 1204 of the interior volume 1209 of the vehicle 1200. An operator can access the battery cells 106 contained within the center battery compartment 1202 by sliding the center battery compartment 1202 outside of the interior volume 1209 along the rails 1220, 1222 to, for example, remove or replace one or more of the battery cells 106 contained within the battery compartment 1202.

Referring to FIG. 13, the center battery compartment 1202 includes a handle 1262 that can be used to push and pull the center battery compartment 1202 into and out of the interior volume 1209 of the vehicle 1200 and that can accessed by an operator when the tailgate 1212 of the vehicle 1200 is raised. For example, an operator can pull outwards on the handle 1262 in order to expose the center battery compartment 1202 and access the battery cells 106 contained within the center battery compartment 1202. The operator can then push inward on the handle 1262 to slide the center battery compartment 1202 back into the interior volume 1209 of the vehicle 1200 beneath floor panel 1203 in order to prevent the battery cells 106 contained within the center battery compartment 1202 from contacting objects outside the vehicle 1200. In some embodiments, the center battery compartment 1202 includes an elastomeric seal to prevent moisture from entering the center battery compartment 1202.

In some implementations, the center battery compartment 1202 includes a locking mechanism 1270 substantially similar to locking mechanisms 170, 172, 174, 176 of FIG. 1-3. Locking mechanism 1270 can prevent movement of the center battery compartment 1202 from the closed position into an open position when the locking mechanism 1270 is engaged in a locked position.

Similar to the vehicle 100 depicted in FIGS. 1-6, the refuse collection vehicle 1200 includes an ejector panel 1235 that is positioned within the refuse storage compartment 1211 and that is mechanically coupled to an ejector electric actuator(s) (e.g., similar to ejector electric actuator 134 of FIG. 2). The profile of the ejector panel 1235 is shaped to contact the side walls 1266, 1267, the top surface 1272, the floor 1204, and the surface the floor panel 1203 as the ejector panel 1235 moves longitudinally within the refuse storage compartment 1211 to eject refuse from the refuse storage compartment 1211.

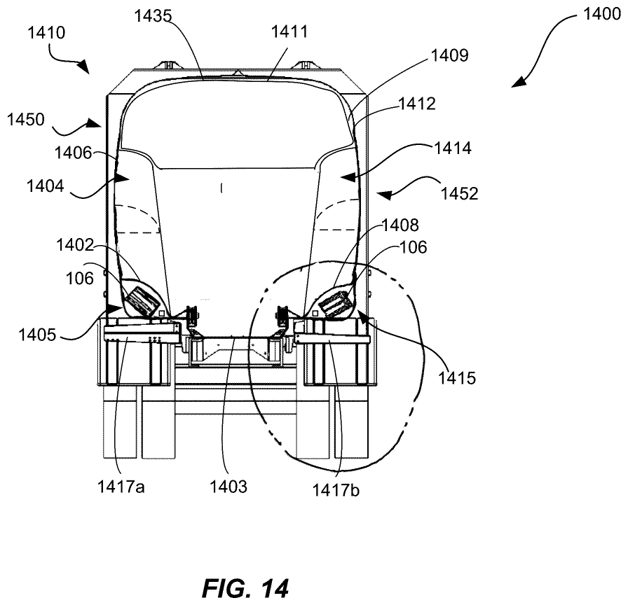

While the battery compartments 104, 105, 114, 115, 504, 505, 514, 515, 604, 605, 614, 615 have each been described as being separated from the refuse storage compartment 111, 511, 611, 911, 1211 by a curved portion 352, 354, 902, 908, 945, 956 of either the floor or the top surface of the interior volume, in some implementations, the battery compartments are separated from the refuse storage compartment curved panels that are fixed to one or more surfaces of the interior volume. For example, FIG. 14 depict a refuse collection vehicle 1400 that is similar to vehicle 100 of FIGS. 1-4B, but the battery compartments 1404, 1405, 1414, 1415 of the vehicle 1400 are each separated from the refuse storage compartment 111 by respective panels 1402, 1408 coupled within the interior volume 1409 of the body 1410 of the vehicle 1400. A first panel 1402 is coupled to the floor 1403 of the refuse storage compartment 1411 and a side wall 1406 of the refuse storage compartment 1411 to separate the battery compartments 1404, 1405 on the street-facing side 1450 of the vehicle 1400 from the refuse storage compartment 1411. Similarly, a second panel 1408 is coupled to the floor 1403 of the refuse storage compartment 1411 and another side wall 1412 of the refuse storage compartment 1411 to separate the battery compartments 1414, 1415 on the curb-facing side 1452 of the vehicle 1400 from the refuse storage compartment 1411. Each of the panels 1402, 1408 separating the battery compartments 1404, 1405, 1414, 1415 from the refuse storage compartment 1411 is curved inwards towards a center of the refuse storage compartment 1411 to define a space within the interior volume 1409 of the body 1410 corresponding to the respective battery compartments 1404, 1405, 1414, 1415. Each of the battery compartments 1404, 1405, 1414, 1415 are positioned within the interior volume 1409 of the vehicle 1400 between

In some implementations, each battery compartment 1404, 1405, 1414, 1415 has a volume up to 0.22 cubic feet. In some implementations, each battery compartment 1404, 1405, 1414, 1415 has a volume of 0.11 cubic feet. In some implementations, the volume of the battery compartments 1404, 1405, 1414, 1415 accounts for 0.44 cubic feet of the total volume of the interior volume 109 of the vehicle 100.

The panels 1402, 1408 separating the battery compartments 1404, 1405, 1414, 1415 from the refuse storage compartment 1411 can form a liquid tight barrier between the refuse storage compartment 1411 and the respective battery compartments 1404, 1405, 1414, 1415, which prevents any solids or liquids contained within the refuse storage compartment 1411 from entering the battery compartments 1404, 1405, 1414, 1415. The panels 1402, 1408 are configured to support the weight of the refuse that is positioned within the body over the battery compartments and distribute the load of the refuse to the side walls 1406, 1412 and frame rails 1417a, 1417b of the vehicle 1400.

Similar to battery compartments 104, 105, 114, 115 of FIGS. 1-4D, the battery compartments 1404, 1405, 1414, 1415 can each include one or more support structures 402 for supporting the battery cells 106 within the respective battery compartments 1404, 1405, 1414, 1415. The panels 1402, 1408 support the weight of the battery cells 106 and support structure(s) 402 coupling the battery cells 106 to the respective battery compartments 1404, 1405, 1414, 1415. In some implementations, the panels 1402, 1408 are welded to the floor 1403 and to the respective side walls 1406, 1412. In some implementations, the panels 1402, 1408 are integrally formed with the side walls 1406, 1412 of the interior volume 1409.

Each of the battery compartments 1404, 1405, 1414, 1415 is covered by a respective exterior cover panel (e.g., similar to cover panels 160, 162, 164, 166 of FIGS. 1-3) that are coupled to an exterior surface of the body 1410 of the refuse collection vehicle 100 and can be raised and lowered in order to provide access to and protect the battery cells 106 within the respective battery compartments 1404, 1405, 1414, 1415. In some implementations, each of the exterior cover panels is coupled to an exterior surface of the body 1410 using a pinned or hinged connection and rotates about the pinned or hinged connection between an open position (i.e., a raised position) and closed position (i.e., a lowered position). For example, an operator can raise an exterior cover panel 166 in order to access the battery cells 106 contained within the respective battery compartment 1404, 1405, 1414, 1415 through an opening in the respective side wall 1406, 1412 of the body 1410. When in the lowered position, the exterior cover panels cover a respective opening in the respective side wall 1406, 1412 of the body 1410, which prevents contact between the battery cells 106 contained within the battery compartment 1404, 1405, 1414, 1415 that is accessible through the respective opening and objects outside the vehicle. In some embodiments, each of the exterior cover panels includes an elastomeric seal to prevent moisture from entering the respective battery compartments 1404, 1405, 1414, 1415.

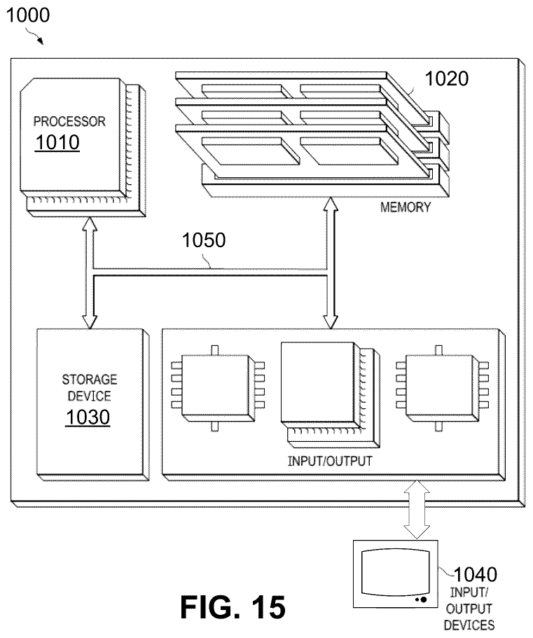

FIG. 15 is a schematic illustration of an example control system or controller for a waste collection vehicle according to the present disclosure. For example, the controller 1000 may include or be part of the controllers 107 shown in FIGS. 1-13. The controller 1000 is intended to include various forms of digital computers, such as printed circuit boards (PCB), processors, digital circuitry, or otherwise. Additionally, the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The controller 1000 includes a processor 1010, a memory 1020, a storage device 1030, and an input/output device 1040. Each of the components 1010, 1020, 1030, and 1040 are interconnected using a system bus 1050. The processor 1010 is capable of processing instructions for execution within the controller 1000. The processor may be designed using any of a number of architectures. For example, the processor 1010 may be a CISC (Complex Instruction Set Computers) processor, a RISC (Reduced Instruction Set Computer) processor, or a MISC (Minimal Instruction Set Computer) processor.

In one implementation, the processor 1010 is a single-threaded processor. In another implementation, the processor 1010 is a multi-threaded processor. The processor 1010 is capable of processing instructions stored in the memory 1020 or on the storage device 1030 to display graphical information for a user interface on the input/output device 1040.

The memory 1020 stores information within the controller 1000. In one implementation, the memory 1020 is a computer-readable medium. In one implementation, the memory 1020 is a volatile memory unit. In another implementation, the memory 1020 is a non-volatile memory unit.

The storage device 1030 is capable of providing mass storage for the controller 1000. In one implementation, the storage device 1030 is a computer-readable medium. In various different implementations, the storage device 1030 may be a floppy disk device, a hard disk device, an optical disk device, or a tape device.

The input/output device 1040 provides input/output operations for the controller 1000. In one implementation, the input/output device 1040 includes a joystick. In some implementations, the input/output device 1040 includes a display unit for displaying graphical user interfaces. For example in some implementations, the input/output device 1040 is a display device that includes one or more buttons and/or a touchscreen for receiving input from a user. In some implementations, the input/output device 1040 includes a keyboard and/or a pointing device. In some implementations, the input/output device 1040 is located within a cab of a refuse collection vehicle (e.g., within cab 108 of vehicle 100). For example, the input/output device 1040 can be attached to or incorporated within a dashboard inside the cab of a refuse collection vehicle.

Although the following detailed description contains many specific details for purposes of illustration, it is understood that one of ordinary skill in the art will appreciate that many examples, variations and alterations to the following details are within the scope and spirit of the disclosure. Accordingly, the exemplary implementations described in the present disclosure and provided in the appended figures are set forth without any loss of generality, and without imposing limitations on the claimed implementations.

Although the present implementations have been described in detail, it should be understood that various changes, substitutions, and alterations can be made hereupon without departing from the principle and scope of the disclosure. Accordingly, the scope of the present disclosure should be determined by the following claims and their appropriate legal equivalents.

The singular forms “a”, “an” and “the” include plural referents, unless the context clearly dictates otherwise.

As used in the present disclosure and in the appended claims, the words “comprise,” “has,” and “include” and all grammatical variations thereof are each intended to have an open, non-limiting meaning that does not exclude additional elements or steps.

As used in the present disclosure, terms such as “first” and “second” are arbitrarily assigned and are merely intended to differentiate between two or more components of an apparatus. It is to be understood that the words “first” and “second” serve no other purpose and are not part of the name or description of the component, nor do they necessarily define a relative location or position of the component. Furthermore, it is to be understood that that the mere use of the term “first” and “second” does not require that there be any “third” component, although that possibility is contemplated under the scope of the present disclosure.

What is claimed is:

1. A refuse collection vehicle, comprising:
a chassis;
a refuse collecting body supported by the chassis;
a tailgate coupled to the refuse collecting body; and
at least one battery compartment configured to receive one or more batteries, the at least one battery compartment positioned within an interior volume of the refuse collecting body.

2. The refuse collection vehicle of claim 1, wherein a longitudinal axis of the at least one battery compartment is aligned with a longitudinal axis of the refuse collecting body.

3. The refuse collection vehicle of claim 1, wherein the interior volume comprises a refuse collection area and the at least one battery compartment is separated from refuse collection area.

4. The refuse collection vehicle of claim 3, wherein the at least one battery compartment is separated from refuse collection area by a portion of a floor of the refuse collecting body.

5. The refuse collection vehicle of claim 4, wherein a portion of the floor is curved inward to define a space corresponding to the at least one battery compartment.

6. The refuse collection vehicle of claim 3, wherein the at least one battery compartment is separated from refuse collection area by at least one panel that covers the battery compartment.

7. The refuse collection vehicle of claim 6, wherein the at least one panel is curved inward to define a space corresponding to the at least one battery compartment.

8. The refuse collection vehicle of claim 3, further comprising an ejector configured to eject refuse from the refuse collection area.

9. The refuse collection vehicle of claim 1, further comprising one or more body components powered by the one or more batteries.

10. The refuse collection vehicle of claim 1, wherein the at least one battery compartment is positioned above a frame rail of the chassis.

11. The refuse collection vehicle of claim 1, further comprising a panel configured to cover the at least one battery compartment.

12. The refuse collection vehicle of claim 11, wherein the panel can be moved between an open position and a closed position.

13. The refuse collection vehicle of claim 12, wherein the one or more batteries can be accessed from outside the refuse collecting vehicle when the panel is in an open position.

14. The refuse collection vehicle of claim 12, wherein the one or more batteries cannot be accessed from outside the refuse collecting vehicle when the panel is in a closed position.

15. The refuse collection vehicle of claim 11, wherein the panel comprises an upper portion configured to cover the one or more batteries and a lower portion configured to cover cabling attached to the one or more batteries.

16. The refuse collection vehicle of claim 1, wherein the at least one battery compartment comprises at least one support structure configured to support the one or more batteries.

17. The refuse collection vehicle of claim 16, wherein the at least one support structure is angled downwards towards a center line of the interior volume.

18. The refuse collection vehicle of claim 1, further comprising a plurality of cables configured to electrically couple the one or more batteries to a battery management system.

19. The refuse collection vehicle of claim 1, wherein the at least one battery compartment comprises:
a first battery compartment positioned proximate a first side of the interior volume; and
a second battery compartment positioned proximate a second side of the interior volume opposite the first side of the interior volume.

20. The refuse collection vehicle of claim 19, further comprising cabling that electrically couples one or more batteries in the first battery compartment and one or more batteries in the second battery compartment to a battery management system.

21. The refuse collection vehicle of claim 20, further comprising a channel extending between the first battery compartment and the second battery compartment, wherein the cabling is positioned within the channel.

22. The refuse collection vehicle of claim 19, wherein the at least one battery compartment further comprises:
a third battery compartment positioned proximate the first side of the interior volume; and
a fourth battery compartment positioned proximate the second side of the interior volume.

23. The refuse collection vehicle of claim 1, wherein the one or more batteries comprises 20 batteries.

24. The refuse collection vehicle of claim 1, further comprising a charging port for charging the one or more batteries.

25. The refuse collection vehicle of claim 1, further comprising one or more sensors to detect at least one of a voltage, a temperature, or a charging level of each battery of the one or more batteries.
